(19) United States
(12) Patent Application Publication
(10) Pub. No.: US 2015/0324031 A1
(43) Pub. Date: Nov. 12, 2015

(54) Touch Panel

(71) Applicant: Hwang Gon JEON, Changwon-si (KR)

(72) Inventor: Hwang Gon JEON, Changwon-si (KR)

(73) Assignee: Dongbu HiTek Co., Ltd., Seoul (KR)

(21) Appl. No.: 14/559,703

(22) Filed: Dec. 3, 2014

(30) Foreign Application Priority Data
May 12, 2014 (KR) 10-2014-0056205

(51) Int. Cl. G06F 3/044; G06F 1/16; G06F 3/041

(52) U.S. Cl. CPC G06F 3/044; G06F 3/0416; G06F 1/16; G06F 2203/04111

(57) ABSTRACT

Provided is a touch panel including a driving line extending in a first direction and first and second sensing lines extending in a second direction intersecting the first direction. A first end of the first sensing line and a first end of the second sensing line are connected with each other. One of the second ends of the first and second driving lines is connected to a driving unit configured to provide driving signals.

### CROSS-REFERENCE TO RELATED APPLICATION

This application claims priority to Korean Patent Application No. 10-2014-0056205, filed on May 12, 2014, and all the benefits accruing therefrom under 35 U.S.C. §119, the contents of which are incorporated by reference in their entirety.

### BACKGROUND

The present disclosure relates to a touch panel. In more detail, the present disclosure relates to a mutual capacitance type touch panel.

In general, a touch panel may be used as an input device for a data processing device, for example, a personal computer or a portable communication device. The touch panel may be classified as a resistive type, a capacitive type, and an electromagnetic type.

For example, a mutual capacitance type touch panel may detect a touch position by measuring a mutual capacitance between a driving line and a sensing line that is changed by a user's touch.

FIG. 1 is a schematic and/or plan view illustrating a typical mutual capacitance type touch panel. FIGS. 2 and 3 are schematic views illustrating signals detected from a sensing line shown in FIG. 1.

Referring to FIG. 1, the typical mutual capacitance type touch panel 10 may include a plurality of driving lines 20 extending in a first direction, for example, an X-axis direction, and a plurality of sensing lines 30 on or over the driving lines 20 and extending in a second (e.g., orthogonal) direction, for example, a Y-axis direction.

When driving signals are sequentially applied to the driving lines 20, a mutual capacitance generated when the driving signals are applied may be detected from the sensing lines 30.

The end portions of the driving lines 20 may be connected to a driving unit (not shown) for providing the driving signals through driving traces 22 and driving pads 24, and the end portions of the sensing lines 30 may be connected to a sensing unit (not shown) for measuring the mutual capacitance through sensing traces 32 and sensing pads 34.

Referring to FIGS. 2 and 3, when driving signals are respectively applied to a first driving line 20A that is relatively far from the sensing unit and a second driving line 20B that is relatively close to the sensing unit, first signals corresponding to the first driving line 20A and second signals corresponding to the second driving line 20B may be detected from the sensing lines 30.

The first signals and the second signals may be detected differently as shown in the drawings. The difference between the first signals and the second signals may be due to an electrical resistance and a parasitic capacitance of the sensing lines 30, and may reduce or deteriorate the linearity and accuracy of the touch panel 10.

### SUMMARY

The present disclosure provides a touch panel capable of detecting and/or processing signals from sensing lines more uniformly.

In accordance with one or more exemplary embodiments, a touch panel may include a driving line extending in a first direction and first and second sensing lines extending in a second direction intersecting the first direction. Each of the first sensing line and the second sensing line have a first end or first end portion and a second end or second end portion, and the first end or first end portion of each of the first sensing line and the second sensing line may be connected with each other. One of the second ends or second end portions of the first and second sensing lines may be connected to a sensing unit configured to measure a mutual capacitance.

The sensing unit may measure a sum of a first mutual capacitance occurring at a first point where the driving line and the first sensing line intersect and a second mutual capacitance occurring at a second point where the driving line and the second sensing line intersect. Thus, the mutual capacitance measured by the sensing unit may be the sum of the first and second mutual capacitances.

The first sensing line has a width that may be the same as (equal to) that of the second sensing line.

The width of the first sensing line may be less than an interval between the first and second sensing lines.

The driving line has a width that may be greater than the sum of the width of the first sensing line and the width of the second sensing line.

In accordance with another exemplary embodiment, a touch panel may include a first driving line and a second driving line extending in a first direction and a first sensing line and a second sensing line extending in a second direction intersecting the first direction. Each of the first sensing line and the second sensing lines has a first end or first end portion and a second end or second end portion, the first ends or first end portions of the first sensing line and the second sensing line may be connected with each other, and one of the second ends or second end portions of the first and second sensing lines may be connected to a sensing unit configured to measure a mutual capacitance. Each of the first driving line and the second driving line has a first end or first end portion and a second end or second end portion, wherein the first ends or first end portions of the first driving line and the second driving line may be connected with each other, and one of the second ends or second end portions of the first and second driving lines may be connected to a driving unit to configured to provide driving signals.

The sensing unit may measure a sum of a first mutual capacitance occurring at a first point where the first driving line and the first sensing line intersect, a second mutual capacitance occurring at a second point where the first driving line and the second sensing line intersect, a third mutual capacitance occurring at a third point where the second driving line and the first sensing line intersect, and a fourth mutual capacitance occurring at a fourth point where the second driving line and the second sensing line intersect. Thus, the mutual capacitance measured by the sensing unit may be the sum of the first, second, third and fourth mutual capacitances.

The first sensing line has a width that may be the same as (equal to) that of the second sensing line.

The width of the first sensing line may be less than an interval between the first and second sensing lines.

The first driving line has a width that may be the same as (equal to) that of the second driving line.

The width of the first driving line may be greater than an interval between the first and second driving lines.

A sum of the width of the first driving line and the width of a second driving line may be greater than a sum of the width of the first sensing line and the width of the second sensing line.

In accordance with still another exemplary embodiment, a touch panel may include a first driving line and a second driving line extending in a first direction, a sensing line extending in a second direction intersecting the first direction. Each of the first driving line and the second driving line have a first end or first end portion and a second end or second end portion, and the first end or first end portions of the first and second driving lines may be connected with each other, and one of the second ends or second end portions of the first and second driving lines may be connected to a driving unit configured to provide driving signals.

### BRIEF DESCRIPTION OF THE DRAWINGS

Exemplary embodiments can be understood in more detail from the following description taken in conjunction with the accompanying drawings, in which:

FIG. 1 is a schematic plan view illustrating a conventional mutual capacitance type touch panel.

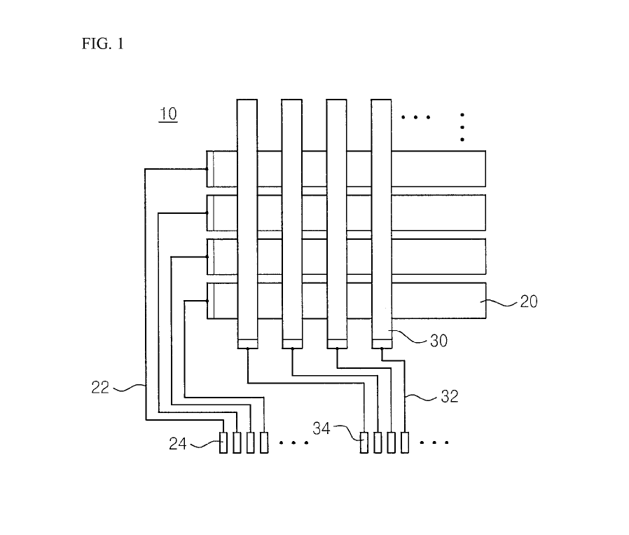

FIGS. 2 and 3 are schematic views illustrating exemplary signals detected from a sensing line shown in FIG. 1;

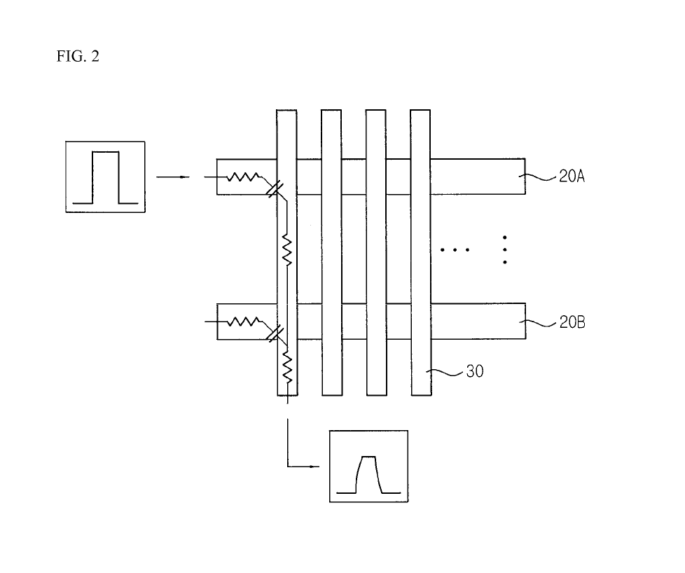

FIG. 4 is a schematic plan view illustrating an exemplary touch panel in accordance with one or more embodiments;

FIG. 5 is a cross-sectional view illustrating part of the exemplary touch panel shown in FIG. 4;

FIGS. 6 and 7 are schematic views illustrating a change capacitance (e.g., a mutual capacitance) by a user's touch;

FIGS. 8 and 9 are schematic views illustrating exemplary signals detected from one or more sensing lines (e.g., a sensing line pair) shown in FIG. 4;

FIG. 10 is a schematic and/or plan view illustrating an exemplary touch panel in accordance with one or more further embodiments;

FIGS. 11 and 12 are schematic views illustrating exemplary signals detected from sensing lines shown in FIG. 10;

FIG. 13 is a schematic and/or plan view illustrating an exemplary touch panel in accordance with one or more still further embodiments; and

FIG. 14 is a schematic sectional view illustrating one or more exemplary driving lines (e.g., a driving line pair) and one or more exemplary sensing lines (e.g., a sensing line pair) shown in FIG. 13.

### DETAILED DESCRIPTION OF EMBODIMENTS

Hereinafter, specific embodiments will be described in more detail with reference to the accompanying drawings. The present invention may, however, be embodied in different forms and should not be construed as being limited to the embodiments set forth herein. Rather, these embodiments are provided so that this disclosure will be thorough and complete, and will fully convey the scope of the present invention to those skilled in the art.

It will also be understood that when a layer, a film, a region or a plate is referred to as being ‘on’ another one, it can be directly on the other one, or one or more intervening layers, films, regions or plates may also be present. Unlike this, it will also be understood that when a layer, a film, a region or a plate is referred to as being ‘directly on’ another one, it is directly on the other one, and one or more intervening layers, films, regions or plates do not exist. Also, though terms like “a first,” “a second,” and “a third” are used to describe various components, compositions, regions and layers in various embodiments of the present invention, the invention is not limited to these terms.

In the following description, the technical terms are used only for explaining specific embodiments while not limiting the present invention. Unless otherwise defined herein, all the terms used herein, which include technical or scientific terms, may have the same meaning that is generally understood by those skilled in the art. In general, terms defined in the dictionary should be considered to have the same meaning as the contextual meaning of the related art, and, unless clearly defined herein, should not be understood as having an abnormally or excessively formal meaning.

The exemplary embodiments of the present invention are described herein with reference to schematic diagrams of ideal embodiments of the present invention. Accordingly, changes in the shapes of the diagrams, for example, changes in manufacturing techniques and/or allowable errors or variations, are sufficiently expected. Accordingly, embodiments of the present invention are not described as being limited to specific shapes described with the diagrams, and include deviations in the shapes. Also, the areas (relative and absolute) described with drawings are entirely schematic and their shapes do not necessarily represent accurate shapes and also do not limit the scope of the present invention.

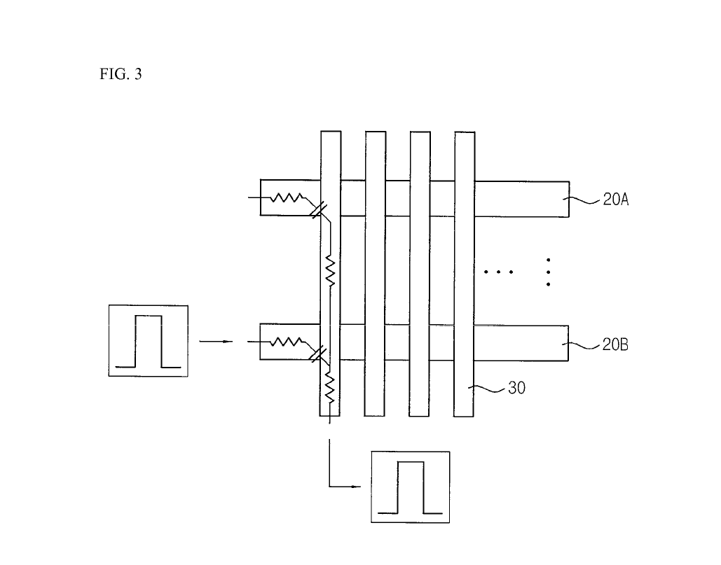

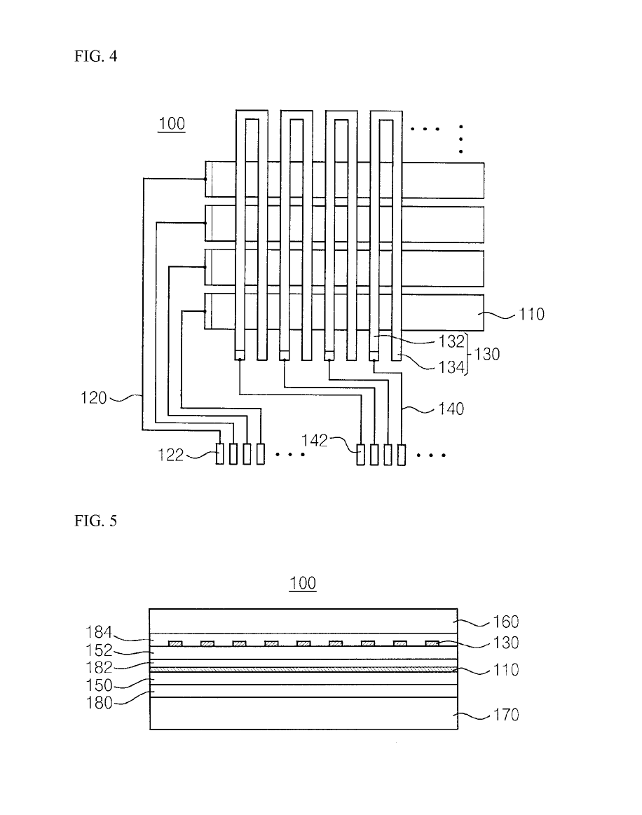

FIG. 4 is a schematic plan view illustrating an exemplary touch panel in accordance with one or more embodiments, and FIG. 5 is a schematic and/or sectional view illustrating part of the exemplary touch panel shown in FIG. 4.

Referring to FIGS. 4 and 5, a touch panel 100 may include driving lines 110 extending in a first direction (for example, an X-axis direction), and sensing lines 130 extending in a second direction intersecting the first direction (for example, a Y-axis direction).

For example, the driving lines 110 and the sensing lines 130 may intersect at right angles. Thus, the driving lines 110 may be orthogonal to the sensing lines 130. Further, the driving lines 110 may be arranged in the second direction, and the sensing lines 130 may be arranged in the first direction.

The driving lines 110 may be formed on a first insulating layer 150 and the sensing lines 130 may be formed on a second insulating layer 152. Additionally, a window glass 160 may be disposed on the sensing lines 130 and a display panel 170 such as a liquid crystal display panel may be under the driving lines 110. In various embodiments, the driving lines 110, the sensing lines 130, the first insulating layer 150 and the second insulating layer 152 may be formed on either the window glass 160 or the display panel 170, and the other of the window glass 160 and the display panel 170 may be placed (e.g., adhered or affixed) thereon or thereto.

For example, a first adhesive layer 180 may be formed or deposited on the display panel 170, and the first insulating layer 150 formed thereon. A second adhesive layer 182 may be formed or deposited on the first insulating layer 150 and the driving lines 110, and the second insulating layer 152 formed thereon. A third adhesive layer 184 may be formed or deposited on the second insulating layer 152 and the sensing lines 130, and the window glass 160 placed thereon.

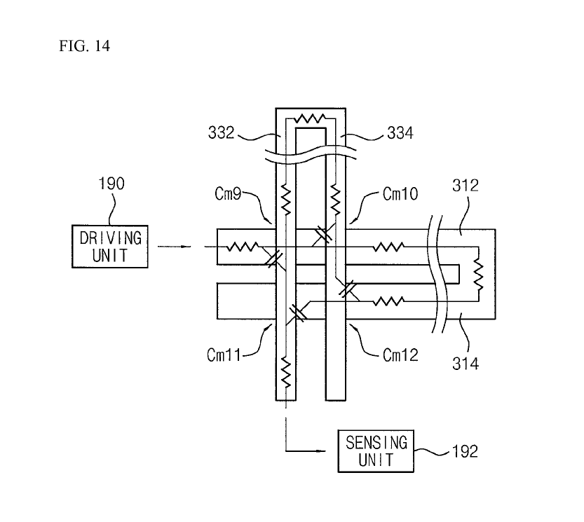

The driving lines 110 may be connected to a driving unit 190 (see FIG. 14) configured to provide driving signals through driving traces 120 and driving pads 122, and the sensing lines 130 may be connected to a sensing unit 192 (see FIG. 14) configured to measure a mutual capacitance through sensing traces 140 and sensing pads 142.

The driving unit 190 may sequentially apply driving signals to the driving lines 110 and accordingly, a mutual capacitance may occur between each of the driving lines 110 and each of the sensing lines 130.

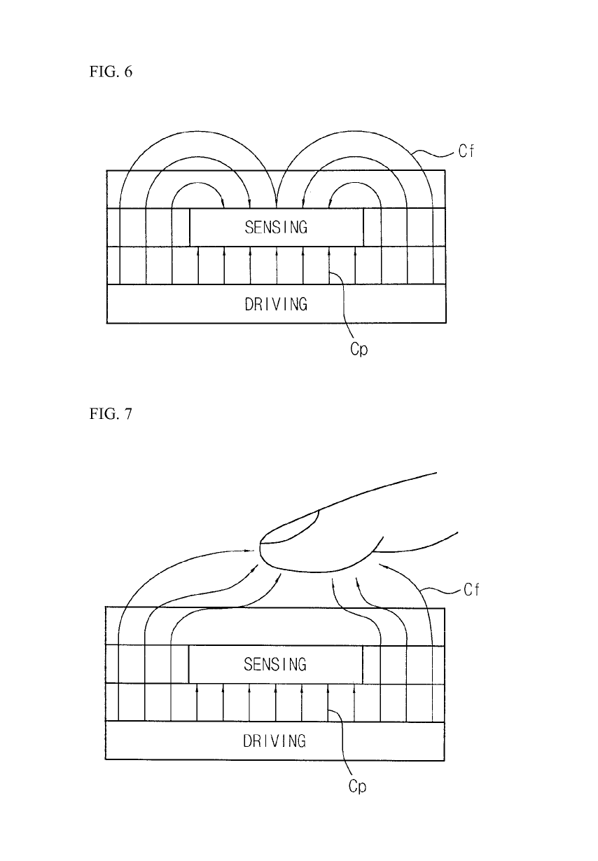

FIGS. 6 and 7 are schematic views illustrating a change of a mutual capacitance by a user's touch.

Referring FIG. 6, the mutual capacitance may include a capacitance (e.g., parasitic capacitance) Cp occurring in an area where the driving line 110 and the sensing line 130 overlap, and a fringing capacitance Cf occurring around the overlapping area.

Referring to FIG. 7, when a user (e.g., a user's hand or fingertip) touches a top surface of the window glass 160, the capacitance (e.g., a mutual capacitance) may change between the driving line 110 and the sensing line 130. In more detail, capacitive coupling may be induced between the driving line 110 and the user, and due to this, the fringing capacitance Cf may be reduced.

As a result, the capacitance (e.g., a mutual capacitance) may be reduced at the position where the user touches the display shown through the window glass 160, and the sensing unit 192 may detect a touch position using the change in the capacitance (e.g., the mutual capacitance).

Referring to FIG. 4 again, according to one or more embodiments of the present invention, each of the sensing lines 130 may include a first sensing line 132 and a second sensing line 134 (e.g., a sensing line pair). The first sensing line 132 and the second sensing line 134 may be connected to each other. In more detail, a first end or first end portion of the first sensing line 132 and a first end or first end portion of the second sensing line 134, which are adjacent to each other, may be connected with each other. Also, one of the second ends or second end portions of the first and second sensing lines 132 and 134, for example, the second end or second end portion of the first sensing line 132, may be connected to the sensing unit 192.

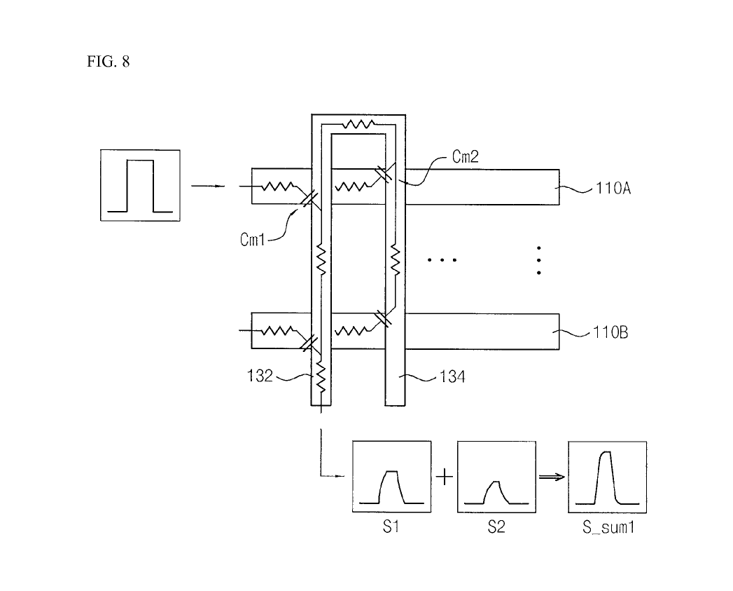

FIGS. 8 and 9 are schematic views illustrating exemplary signals detected from the exemplary sensing line (e.g., sensing line pair) shown in FIG. 4.

Referring to FIG. 8, when a driving signal is applied to a driving line 110A that is relatively far from the second end or second end portion of the first sensing line 132 connected to the sensing unit 192, a first capacitance (e.g., mutual capacitance Cm1) may occur at the point where the driving line 110A and the first sensing line 132 intersect, and a second capacitance (e.g., mutual capacitance Cm2) may occur at the point where the driving line 110A and the second sensing line 134 intersect.

Since the first sensing line 132 and the second sensing line 134 are connected with each other, a capacitance (e.g., mutual capacitance) measured by the sensing unit 192 may be the sum of the first mutual capacitance Cm1 and the second mutual capacitance Cm2. That is, as shown in FIG. 8, a signal measured by the sensing unit 192 may be the sum S_sum1 of a first signal S1 generated by the first mutual capacitance Cm1 and a second signal S2 generated by the second mutual capacitance Cm2.

Referring to FIG. 9, when a driving signal is applied to a driving line 110B that is relatively close to the second end or second end portion of the first sensing line 132 connected to the sensing unit 192, a third capacitance (e.g., mutual capacitance Cm3) may occur at the point where the driving line 110B and the first sensing line 132 intersect, and a fourth capacitance (e.g., mutual capacitance Cm4) may occur at the point where the driving line 110B and the second sensing line 134 intersect.

The capacitance (e.g., a mutual capacitance) measured by the sensing unit 192 may be the sum of the third mutual capacitance Cm3 and the fourth mutual capacitance Cm4. That is, as shown in FIG. 9, a signal measured by the sensing unit 190 may be the sum S_sum2 of a third signal S3 generated by the third mutual capacitance Cm3 and a fourth signal S4 generated by the fourth mutual capacitance Cm4.

The amplitude, waveform, and phase of the first to fourth signals S1, S2, S3, and S4 may vary according to the distance between the second end of the first sensing line 132 and the intersection points. A change of the amplitude, waveform, and phase of the first to fourth signals S1, S2, S3, and S4 may occur due to a delivery distance of the first to fourth signals S1, S2, S3, and S4, a resistance change of the first to fourth signals S1, S2, S3, and S4 according to the delivery distance, and a change of a parasitic capacitance coupled to the delivery path of the first to fourth signals S1, S2, S3, and S4.

However, as shown in FIGS. 8 and 9, the sum of the second signal S2 and the third signal S3 may be substantially similar to the sum of the first signal S1 and the fourth signal S4. Accordingly, when driving signals are sequentially applied to the driving lines 110, measurement signals obtained from the intersection points of the driving lines 110 and the sensing lines 130 may become relatively uniform compared to the conventional art. Especially, since a signal deviation between the driving lines 110 may be compensated as described above, the linearity and accuracy of the touch panel 100 may be improved greatly. The exemplary arrangement of driving lines as shown in FIG. 4 may also reduce the area of the sensing unit 192 and the traces between the sensing unit 192 and the sensing lines 130, and may reduce the length of time necessary to detect the location of the user's touch on the touch screen.

Although the case in which the driving signals are sequentially applied to the driving lines 110 is described, the driving signals may be simultaneously applied to a plurality of driving lines 110, and signals measured from the sensing lines 130 may become uniform. Thus, it is possible to apply various sensing methods using the present invention.

According to one or more exemplary embodiments of the present invention, in order to allow the measurement signals to become more uniform, the width of the first sensing line 132 may be the same as that of the second sensing line 134. Moreover, in order to increase the fringing capacitance, the width of the first and second sensing lines 132 and 134 may be smaller than an interval or spacing between the first and second sensing lines 132 and 134.

Further, in order to improve the linearity and accuracy of the touch panel 100, the interval or spacing between the first and second sensing lines 132 and 134 may be identical to an interval between the sensing lines 130. However, in order to improve the mutual capacitance, the interval or spacing between the sensing lines 130 may be configured to be broader than the interval or spacing between the first and second sensing lines 132 and 134.

Still further, in order to prevent noise from being transmitted from the display panel 170 into the sensing lines 130, the width of the driving lines 110 may be greater than the width of the sensing lines 132 and 134. Particularly, an interval or spacing between the driving lines 110 may be smaller than the interval or spacing between the first and second sensing lines 132 and 134, and accordingly, noise from the display panel 170 to the sensing lines 130 may be prevented or reduced.

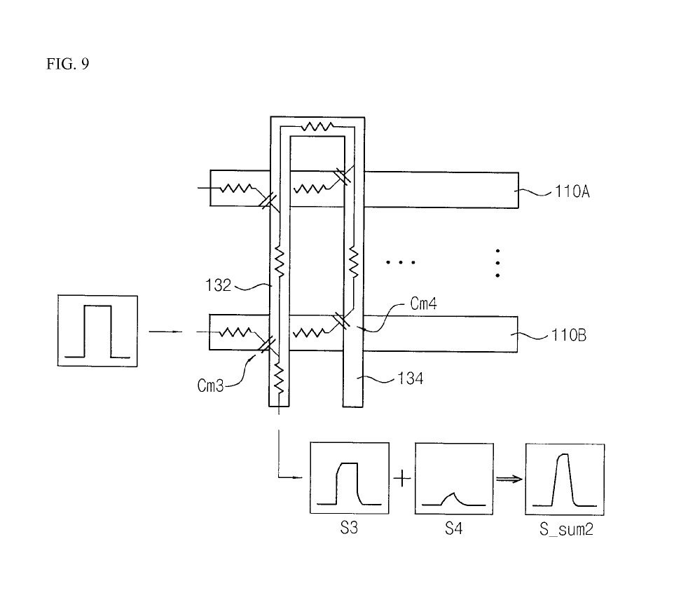

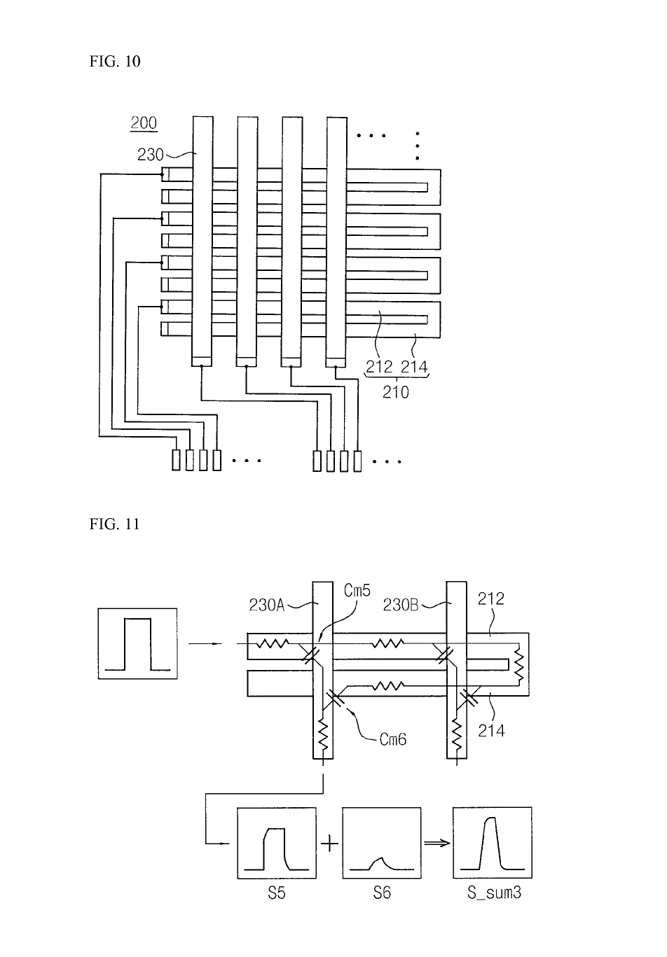

FIG. 10 is a schematic plan view illustrating an exemplary touch panel in accordance with one or more other embodiments. FIGS. 11 and 12 are schematic views illustrating exemplary signals detected from sensing lines shown in FIG. 10.

Referring to FIG. 10, an exemplary touch panel 200 may include driving lines 210 extending in a first direction (for example, an X-axis direction), and sensing lines 230 extending in a second direction intersecting the first direction (for example, a Y-axis direction). For example, the driving lines 210 and the sensing lines 230 may be orthogonal (e.g., intersect each other at right angles). Additionally or alternatively, the driving lines 210 may be arranged in the second direction, and the sensing lines 230 may be arranged in the first direction.

Each of the driving lines 210 may include a first driving line 212 and a second driving line 214, and a first end or first end portion of the first driving line 212 and a first end or first end portion of the second driving line 214 may be connected with each other. The driving unit 190 providing the driving signals may be connected to one of second ends or second end portions of the first and second sensing lines 212 and 214 (for example, the second end or second end portion of the first sensing line 212).

Referring to FIG. 11, a fifth capacitance (e.g., mutual capacitance Cm5) may occur at the point where a sensing line 230A and the first driving line 212 intersect, and a sixth capacitance (e.g., mutual capacitance Cm6) may occur at the point where the sensing line 230A and the second driving line 214 intersect, which are adjacent to the driving unit 190.

Accordingly, the sum S_sum3 of a fifth signal S5 generated from the fifth mutual capacitance Cm5 and a sixth signal S6 generated from the sixth mutual capacitance Cm6 may be detected from the sensing line 230A.

Referring to FIG. 12, a seventh capacitance (e.g., mutual capacitance Cm7) may occur at the point where a sensing line 230B and a first driving line 212 intersect, and an eighth capacitance (e.g., mutual capacitance Cm8) may occur at the point where the sensing line 230B and the second driving line 214 intersect, which are relatively far from the driving unit 190.

Accordingly, the sum S_sum4 of a seventh signal S7 generated from the seventh mutual capacitance Cm7 and an eighth signal S8 generated from the eighth mutual capacitance Cm8 may be detected from the sensing line 230B.

As shown in the drawings, the fifth to eighth signals S5, S6, S7, and S8 may be detected differently according to an electrical resistance of the first and second driving lines 212 and 214. However, the sum S_sum3 of the fifth signal S5 and the sixth signal S6 may be substantially similar to the sum S_sum4 of the seventh signal S7 and the eighth signal S8. As a result, signals detected from the sensing lines 230 may become relatively or entirely uniform. Since a signal deviation between the sensing lines 230 is compensated as described above, the linearity and accuracy of the touch panel 200 may be improved greatly. The exemplary arrangement of driving lines as shown in FIG. 10 may also reduce the area of the driving unit 190 and the traces between the driving unit 190 and the driving lines 210, and may reduce the length of time necessary to detect the location of the user's touch on the touch screen.

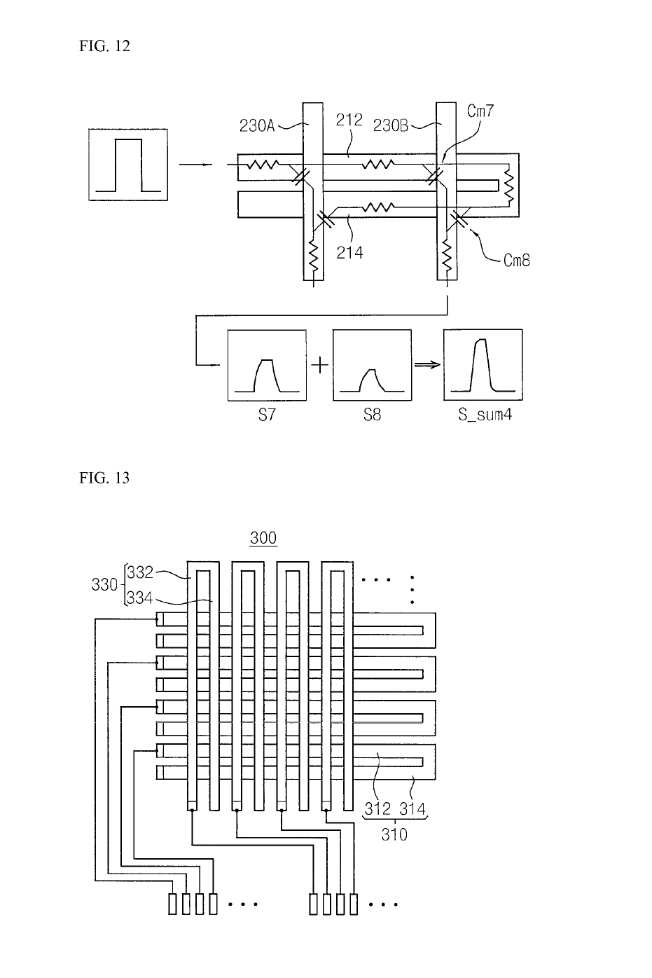

FIG. 13 is a schematic plan view illustrating an exemplary touch panel in accordance with one or more still further embodiments. FIG. 14 is a schematic view illustrating a driving line and a sensing line shown in FIG. 13.

Referring to FIGS. 13 and 14, an exemplary touch panel 300 may include driving lines 310 extending in a first direction (for example, an X-axis direction), and sensing lines 330 extending in a second direction intersecting the first direction (for example, a Y-axis direction). For example, the driving lines 310 and the sensing lines 330 may be orthogonal (e.g., intersect each other at right angles). Additionally or alternatively, the driving lines 310 may be arranged in the second direction, and the sensing lines 330 may be arranged in the first direction.

Each of the sensing lines 330 may include a first sensing line 332 and a second sensing line 334, and a first end or first end portion of the first sensing line 332 and a first end or first end portion of the second sensing line 334 may be connected with each other. The sensing unit 192 for measuring a mutual capacitance may be connected to one of the second ends or second end portions of the first and second sensing lines 332 and 334 (for example, the second end or second end portion of the first sensing line 332)5.

Each of the driving lines 310 may include a first driving line 312 and a second driving line 314, and the first ends or first end portions of the first driving line 312 and the second driving line 314 may be connected with each other. The driving unit 190 for providing driving signals may be connected to one of the second ends or second end portions of the first and second sensing lines 312 and 314 (for example, the second end or second end portion of the first sensing line 312).

When a driving signal is applied to the second end or second end portion of the first driving line 312, a ninth capacitance (e.g., mutual capacitance Cm9) occurs at the intersection point of the first driving line 312 and the first sensing line 332, and a tenth capacitance (e.g., mutual capacitance Cm10) may occur at the intersection point of the first driving line 312 and the second sensing line 334. Additionally, an eleventh capacitance (e.g., mutual capacitance Cm11) occurs at the intersection point of the second driving line 314 and the first sensing line 332, and a twelfth capacitance (e.g., mutual capacitance Cm12) may occur at the intersection point of the second driving line 314 and the second sensing line 334.

The four mutual capacitances Cm9, Cm10, Cm11, and Cm12 may occur between the driving line 310 and the sensing line 330, and accordingly, signals generated by mutual capacitances at the intersection points between the driving lines 310 and the sensing lines 330 may be detected uniformly. As a result, since a signal deviation between the driving lines 310 and the sensing lines 330 is compensated, the linearity and accuracy of the touch panel 300 may be improved greatly.

The first and second sensing lines 332 and 334 may have the same width, and in order to improve a fringing capacitance, the width of the first and second sensing lines 332 and 334 may be smaller than an interval or spacing between the first and second sensing lines 332 and 334.

Moreover, the first and second driving lines 312 and 314 may have the same width, and in order to reduce or prevent noise from being transmitted from the display panel 170 to the sensing lines 330, the width of the first and second driving lines 312 and 314 may be greater than an interval or spacing between the first and second driving lines 312 and 314.

Additionally or alternatively, the sum of the widths of the first driving line 312 and the second driving line 314 may be greater than the sum of the widths of the first sensing line 332 and the second sensing line 334.

According to the above-mentioned embodiments of the present invention, the touch panel 300 may include a plurality of driving lines 310 extending in a first direction and a plurality of sensing lines 330 extending in a second direction.

Particularly, each of the sensing lines 330 may include a first sensing line 332 and a second sensing line 334, which are connected with each other, and each of the driving lines 310 may include a first driving line 312 and a second driving line 314, which are connected with each other. Additionally, one of the first and second sensing lines 332 and 334 may be connected to the sensing unit 192, and one of the first and second driving lines 312 and 314 may be connected to the driving unit 190.

Accordingly, signals detected from the sensing lines 330 may become relatively uniform, and accordingly, the linearity and accuracy of the touch panel 300 may be improved greatly.

Although the touch panel has been described with reference to the specific embodiments, it is not limited thereto. Therefore, it will be readily understood by those skilled in the art that various modifications and changes can be made thereto without departing from the spirit and scope of the present invention defined by the appended claims.

What is claimed is:

1. A touch panel comprising:
a driving line extending in a first direction; and
a first sensing line and a second sensing line extending in a second direction intersecting the first direction, wherein each of the first sensing line and the second sensing line comprises a first end and a second end, and the first end of each of the first sensing line and the second sensing line are connected with each other,
wherein one of the second ends of the first and second sensing lines is connected to a sensing unit configured to measure a mutual capacitance.

2. The touch panel of claim 1, wherein the sensing unit measures a sum of a first mutual capacitance occurring at a first point where the driving line and the first sensing line intersect and a second mutual capacitance occurring at a second point where the driving line and the second sensing line intersect.

3. The touch panel of claim 1, wherein the first sensing line has a width substantially equal to that of the second sensing line.

4. The touch panel of claim 3, wherein the width of the first sensing line is less than an interval between the first and second sensing lines.

5. The touch panel of claim 1, wherein the driving line has a width greater than a sum of the width of the first sensing line and a width of the second sensing line.

6. A touch panel comprising:
a first driving line and a second driving line extending in a first direction, wherein each of the first driving line and the second driving line has a first end and a second end, and the first ends of the first driving line and the second driving line are connected with each other; and
a first sensing line and a second sensing line extending in a second direction intersecting the first direction, wherein each of the first sensing line and the second sensing line has a first end and a second end, the first ends of the first and second sensing lines are connected with each other,
wherein one of the second ends of the first and second sensing lines is connected to a sensing unit configured to measure a mutual capacitance; and one of the second ends of the first and second driving lines is connected to a driving unit configured to provide driving signals.

7. The touch panel of claim 6, wherein the sensing unit measures a sum of a first mutual capacitance occurring at a first point where the first driving line and the first sensing line intersect, a second mutual capacitance occurring at a second point where the first driving line and the second sensing line intersect, a third mutual capacitance occurring at a third point where the second driving line and the first sensing line intersect, and a fourth mutual capacitance occurring at a fourth point where the second driving line and the second sensing line intersect.

8. The touch panel of claim 6, wherein the first sensing line has a width substantially equal to that of the second sensing line.

9. The touch panel of claim 8, wherein the width of the first sensing line is less than an interval between the first and second sensing lines.

10. The touch panel of claim 6, wherein the first driving line has a width equal to that of the second driving line.

11. The touch panel of claim 10, wherein the width of the first driving line is greater than an interval between the first and second driving lines.

12. The touch panel of claim 6, wherein a sum of a width of the first driving line and a width of a second driving line is greater than a sum of a width of the first sensing line and a width of the second sensing line.

13. A touch panel comprising:
a first driving line and a second driving line extending in a first direction, each of the first driving line and the second driving line having a first end and a second end, and the first ends of the first and second driving lines are connected with each other; and
a sensing line extending in a second direction intersecting the first direction,
wherein one of the second ends of the first and second driving lines is connected to a driving unit configured to provide driving signals.

14. The touch panel of claim 13, wherein the sensing unit measures a sum of a first mutual capacitance occurring at a first point where the first driving line and the sensing line intersect, and a second mutual capacitance occurring at a second point where the second driving line and the sensing line intersect.

15. The touch panel of claim 13, wherein the first sensing line has a width substantially equal to that of the second sensing line.

16. The touch panel of claim 15, wherein the width of the first driving line is greater than an interval between the first and second driving lines.

17. The touch panel of claim 13, wherein each of the first and second driving lines has a width greater than a width of the sensing line.
